(19) United States
(12) Patent Application Publication
(10) Pub. No.: US 2026/0340177 A1
(43) Pub. Date: Oct. 29, 2026

(54) Systems, Methods, and Computer-Readable Media for a Reference Based Execution Architecture for Securing Large Language Model Integration With Data Environments

(71) Applicant: Dymium Inc., Los Gatos, CA (US)

(72) Inventors: Denzil Wessels, Los Gatos, CA (US); Igor Plotnikov, Sunnyvale, CA (US); Valentyn Kamyshenko, Los Gatos, CA (US)

(21) Appl. No.: 19/635,548

(22) Filed: Mar. 31, 2026

Related U.S. Application Data
(60) Provisional application No. 63/795,069, filed on Apr. 25, 2025.

(51) Int. Cl. G06F 21/62; G06F 8/10; G06F 21/16

(52) U.S. Cl. CPC G06F 21/6227; G06F 8/10; G06F 21/16

(57) ABSTRACT

Systems, methods, and computer-readable media implement a reference based execution architecture that structurally separates large language models and artificial intelligence agents from data environments containing sensitive information. A sensitive data analyzer classifies, indexes, and encodes sensitive data elements, producing metadata records stored in a metadata store that defines the sole channel through which data environment information is accessible to large language model and artificial intelligence agent components. When an artificial intelligence agent requires data, the platform transmits a tokenized data reference object comprising encoded metadata in lieu of the sensitive data. A controlled data interface applies zero trust authorization and generates an immutable audit trail before any retrieval. Retrieved data is directed to a processing tool operating outside the large language model execution context. The separation is structurally enforced independent of behavioral configuration or prompt based constraints. Additional methodologies support metadata informed application programming interface generation with synthetic test data and large language model assisted security policy formulation using transformed metadata.

### CROSS-REFERENCE TO RELATED APPLICATIONS

This application claims priority to and the benefit of U.S. Provisional Patent Application Ser. No. 63/759,069, as filed on Apr. 25, 2025, and titled “Systems, Methods, and Computer-Readable Media for a Reference Based Execution Architecture for Securing Large Language Model Integration with Data Environments,” which is hereby incorporated herein by reference in its entirety. This application is further related to U.S. Provisional Patent Application Ser. No. 63/403,651, as filed on Sep. 2, 2022, and titled “Systems and Methods for Managing Network Security,” which is hereby incorporated herein by reference in its entirety. This application is further related to U.S. Non-Provisional Patent Application Ser. No. 18/240,738, as filed on Aug. 31, 2023, and titled “Systems and Methods for Managing Data Security,” which is hereby incorporated herein by reference in its entirety. This application is further related to U.S. Provisional Patent Application Ser. No. 63/466,641, as filed on May 15, 2023, and titled “Fast Zero Trust Solution to Data Access and Data Integration,” which is hereby incorporated herein by reference in its entirety. This application is further related to U.S. Provisional Patent Application Ser. No. 63/567,385, as filed on Mar. 19, 2024, and titled “Systems and Methods for Ransomware Events,” which is hereby incorporated herein by reference in its entirety. This application is further related to U.S. Non-Provisional patent application Ser. No. 19/081,839, as filed on Mar. 17, 2025, and titled “Systems and Methods for Ransomware Events,” which is hereby incorporated herein by reference in its entirety. This application is further related to U.S. Non-Provisional patent application Ser. No. 18/893,774, as filed on Sep. 23, 2024, and titled “Artificially Intelligent Systems and Methods for Managing Data Security,” which is hereby incorporated herein by reference in its entirety.

### FIELD OF THE DISCLOSURE

Exemplary embodiments relate to systems and methods for data security and, more particularly, to systems, methods, and computer-readable media that implement a reference based execution architecture, enforcing an architectural separation between large language model operational components and enterprise data environments, thereby preventing unauthorized disclosure of sensitive, confidential, or otherwise protected information through LLM mediated workflows.

### SUMMARY

Exemplary embodiments provide systems, methods, and computer-readable media implementing a reference based execution architecture that enforces an architectural separation between LLM and AI agent operational components and enterprise data environments containing sensitive information. The technical improvement provided by exemplary embodiments is the structural displacement of LLMs from the data plane of an enterprise architecture through an enforced, architecturally implemented boundary that is independent of LLM behavioral configuration, prompt based constraints, or model safety alignment—each of which is demonstrably insufficient to prevent unauthorized data disclosure in adversarial conditions.

In exemplary embodiments, a computing platform classifies, indexes, and encodes metadata representations of data elements within an enterprise data environment, generating a structured metadata store comprising data type identifiers, location identifiers, format descriptors, schema representations, and sensitivity classifications, without exposing underlying sensitive data to any LLM component. When an AI agent requires data access, the platform returns a tokenized data reference object comprising encoded metadata in lieu of the sensitive data. Access to actual data is mediated exclusively through a controlled data interface that evaluates each retrieval request against a security policy engine prior to execution, enforces a zero trust authorization model, and generates an immutable audit trail. Data retrieved through the controlled interface is directed to a specialized processing tool operating outside the LLM's execution context. The LLM operates only on processed output. Any execution path through which the large language model could otherwise access raw sensitive data is eliminated at the architecture level rather than managed through behavioral constraints.

In another exemplary embodiment, the platform enables application programming interface generation in which developers interact with a metadata informed LLM to produce accurate API specifications without requiring access to production data at any stage. The platform generates synthetic test data dynamically based on structural and statistical properties encoded in the metadata, producing a realistic development and testing environment while maintaining complete structural isolation of sensitive records.

In yet another exemplary embodiment, the platform enables LLM assisted security policy formulation in which administrators formulate granular, role-based access control policies through LLM assisted sessions that operate on metadata, and optionally on transformed metadata from which actual resource identifiers have been replaced with generic tokens, rather than on business data. These paragraphs introduce the subject matter of the exemplary embodiments and are not intended to limit the scope of any claim.

### BRIEF DESCRIPTION OF THE DRAWINGS

The accompanying drawings are incorporated in and constitute a part of this specification. Together with the detailed description, they serve to explain the principles of the exemplary embodiments.

FIG. 1 is a block diagram illustrating a reference based execution architecture for securing large language model integration with a data environment in accordance with an exemplary embodiment.

FIG. 2 is a flowchart illustrating a method for secure data access within an artificial intelligence agent workflow using a data reference and controlled data interface in accordance with an exemplary embodiment.

FIG. 3 is a flowchart illustrating a method for application programming interface generation using metadata informed large language model assistance and dynamically generated synthetic test data in accordance with an exemplary embodiment.

FIG. 4 is a flowchart illustrating a method for large language model assisted security policy formulation using transformed metadata in accordance with an exemplary embodiment.

FIG. 5 is a layered architecture diagram illustrating the enforced architectural boundaries that structurally separate the large language model and artificial intelligence agent layer from the data environment layer in accordance with an exemplary embodiment.

FIG. 6 is a block diagram illustrating an exemplary integration of the reference based execution architecture with a network security platform employing a Semantic Data Proxy in accordance with an exemplary embodiment.

FIG. 7 is a block diagram illustrating an exemplary integration of the reference based execution architecture with a data security platform employing a data access proxy with identity validation, permission evaluation, and data transformation in accordance with an exemplary embodiment.

FIG. 8 is a block diagram illustrating an exemplary integration of the reference based execution architecture with a zero trust data access and integration platform, showing dual layer zero trust enforcement in accordance with an exemplary embodiment.

FIG. 9 is a flowchart illustrating an exemplary integration of the reference based execution architecture with a ransomware defense platform, showing audit trail based anomaly detection and elevated access restriction in response to a detected ransomware event in accordance with an exemplary embodiment.

FIG. 10 is a block diagram illustrating an exemplary integration of the reference based execution architecture with an extended ransomware defense platform covering file system and cloud storage data sources, showing ransomware status flags encoded within tokenized data reference objects in accordance with an exemplary embodiment.

FIG. 11 is a block diagram illustrating an exemplary integration of the reference based execution architecture with an artificially intelligent data security platform, showing AI generated contextual persona profiles being ingested into the metadata store and applied by the security policy engine for dynamic, context aware authorization in accordance with an exemplary embodiment.

### DETAILED DESCRIPTION OF EXEMPLARY EMBODIMENTS

The following description is presented to enable a person of ordinary skill in the art to make and use the exemplary embodiments and is provided in the context of a patent application. Various modifications to the disclosed embodiments will be apparent to those skilled in the art, and the general principles defined herein may be applied to other embodiments without departing from the scope of the claims.

As used herein, the term “large language model” or “LLM” refers to a machine learning model trained on large data corpora and capable of generating, transforming, summarizing, and reasoning about natural language content. As used herein, the term “AI agent” refers to a software component that operates autonomously or semi-autonomously in conjunction with an LLM to execute tasks, invoke tools, retrieve data, and interact with external systems. As used herein, the term “metadata” refers to structured descriptive information about data, including data type, location, format, schema, and sensitivity classification, without including the substantive content of the data described. As used herein, the term “data reference” refers to a tokenized, structured object that identifies and describes a dataset through metadata without conveying the content of the data itself. As used herein, “reference based execution” refers to a computing paradigm in which AI agent operations that require data access are executed exclusively through data reference objects that are resolved to actual data by a controlled, policy governed interface, such that the LLM operational layer is never in the data path of sensitive information. technical context.

Large language models (hereinafter “LLMs”) have emerged as transformative tools in enterprise computing, offering capabilities in natural language processing, automated reasoning, and analytical decision support that were previously unavailable at commercial scale. Integrating those models into enterprise data environments, however, introduces security vulnerabilities that existing architectures have proven unable to address in any structurally reliable way.

The first category of vulnerability is rooted in how LLMs are built. Contemporary models are trained primarily using objectives that reward helpfulness and response coherence, not confidentiality. These training objectives yield no native mechanism that reliably prevents a model from disclosing sensitive information encountered during inference. This is not a configuration deficiency correctable through operational settings; it reflects a fundamental property of the transformer architectures and attention mechanisms underlying state-of-the-art LLMs. The model's weights encode no notion of data access scope, authorization level, or sensitivity boundary.

Efforts to impose confidentiality through externally applied guardrails—including system prompt restrictions, output classifiers, and content moderation layers—have demonstrated significant limitations. Peer-reviewed research and production deployments have established that external guardrails are susceptible to circumvention through adversarial prompting, multiturn jailbreaking, role-play manipulation, and indirect contextual exploitation. These circumvention techniques are reproducible across commercially deployed LLM systems and represent a persistent, evolving threat that behavioral constraints alone cannot contain. Because external guardrails are enforced at the model output layer, they operate only after the model has already processed—and, from an architectural standpoint, already had access to—the sensitive data. They are therefore not a substitute for structural isolation.

A distinct but equally serious category of vulnerability stems from how organizations provision data access in LLM integrated deployments. LLMs and AI agents operating within enterprise environments are routinely provisioned with direct access to production data stores containing personally identifiable information, confidential business records, financial data, health-related data, and legally protected information. Similarly, application developers building integrations atop LLM platforms are routinely granted access to live production databases for API design, integration testing, and debugging. This access is functionally unnecessary in most cases; developers and AI agents require an understanding of data schema, format, and representative statistical characteristics—not access to actual sensitive records. The routine overprovisioning of data access to both automated systems and human personnel creates multiple exposure pathways exploitable through inadvertent disclosure, insider threat, or compromised credential abuse.

Existing technical countermeasures address one dimension of these risks while leaving others unaddressed. Data masking is schema specific, difficult to maintain as data structures evolve, and does not address the LLM's ability to reconstruct sensitive information from patterns in partially masked data. Synthetic data generation tools require significant manual configuration and frequently produce data of insufficient structural fidelity for realistic development and testing. Role-based access control reduces the scope of overprovisioning but does not address the LLM specific risks arising from model architecture. LLM safety fine-tuning has been repeatedly demonstrated to be ineffective against adversarial circumvention strategies and does not constitute structural isolation. API gateways enforce endpoint level access control but do not prevent LLMs from processing and disclosing sensitive data received through those endpoints. Zero trust network architectures govern connectivity but do not govern what an LLM does with data it legitimately receives. No existing technical approach provides a comprehensive, architecturally enforced separation between the LLM operational domain and the sensitive data plane of an enterprise data environment.

What is needed is a platform that maintains a deep, current, and continuously updated understanding of enterprise data landscapes, including the classification of sensitive data elements across heterogeneous storage systems. Without such a platform level model of the data environment, metadata based approaches to LLM isolation cannot be implemented with the consistency and granularity necessary for operational effectiveness. Furthermore, enterprise application developers currently lack tools for generating accurate API specifications and realistic test data in the absence of access to production data, creating a persistent tension between security and development velocity. Exemplary embodiments address this need through architecturally enforced methods rather than organizational policy or behavioral constraints.

### 1. System Architecture

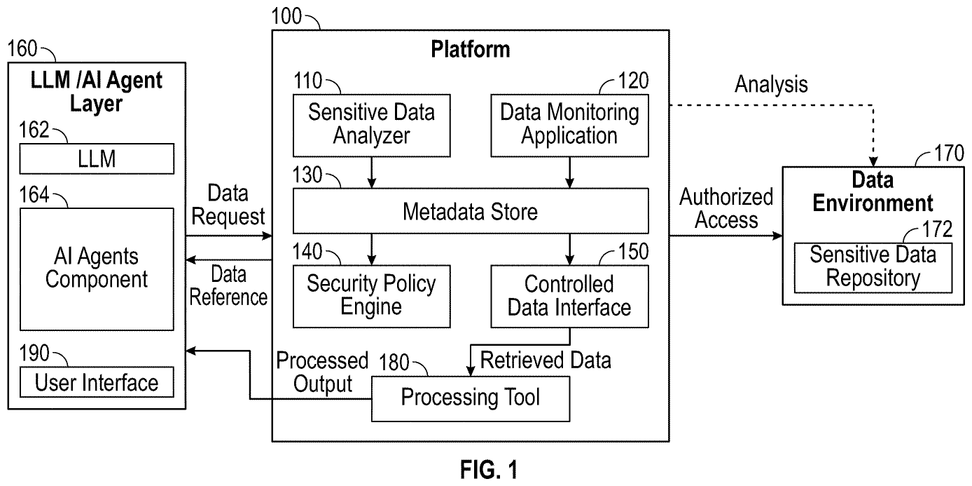

Referring now to FIG. 1, a system 100 implementing a reference based execution architecture for securing large language model integration with a data environment is illustrated. System 100 achieves a technical improvement over prior art LLM deployment architectures by enforcing a structural boundary between the LLM and AI agent operational layer and the enterprise data environment. That boundary is implemented at the system architecture level and is independent of LLM behavioral configuration, prompt based constraints, or model safety alignment. This architectural isolation reduces the exposure surface of sensitive data to a structural minimum and is not subject to circumvention through adversarial prompting or model manipulation techniques that have been demonstrated to defeat behavioral guardrail approaches. The combination of reference based data access, metadata mediated execution, and enforced policy evaluation at the data interface constitutes a novel execution model for AI agent operation that differs structurally from prior access control and API gateway approaches. This architectural constraint modifies the operation of the computing system by removing the large language model from any executable data retrieval path, rather than merely restricting outputs. A key structural feature of this execution model is the substitution of data references for data within the execution path of the AI agent, ensuring that the execution path traversed by the AI agent never carries raw sensitive data content.

Sensitive data analyzer 110 performs classification, indexing, and encoding of sensitive data elements within data environment 170. Sensitive data analyzer 110 employs a combination of neural network classification models, sequence labeling models, and heuristic rule sets tailored to the operational context of the deploying enterprise to identify, categorize, and assign sensitivity levels to data elements. Classification operations performed by sensitive data analyzer 110 include entity recognition for personally identifiable information, pattern based detection of financial record formats, semantic classification of confidential business content, and contextual inference for determining the organizational sensitivity of otherwise nonobvious data elements, among others. Sensitive data analyzer 110 extracts from each classified element a set of feature descriptors comprising at minimum a data type identifier, a sensitivity tier code, a location identifier, and a schema fragment, and encodes these descriptors as structured metadata entries in metadata store 130. Sensitive data analyzer 110 operates as a proprietary, custom component within the platform so as to support model training on enterprise specific data patterns and to prevent the transmission of sensitive data to external classification services.

Alongside the classification pipeline, data monitoring application 120 continuously monitors data streams and repositories within data environment 170 to detect structural changes, schema modifications, and the introduction of new data assets. Data monitoring application 120 maintains the currency and accuracy of metadata store 130 by updating metadata entries in response to detected changes, ensuring that the metadata available to LLM 162 and AI agents 164 accurately reflects the current state of the data landscape. Data monitoring application 120 further analyzes the semantic content of data formats encountered within data environment 170 and builds data transformation pipelines optimized for those formats, enabling efficient and format aware processing operations downstream.

Metadata store 130 persistently holds the structured metadata produced by sensitive data analyzer 110 and data monitoring application 120. Each metadata record in metadata store 130 comprises at minimum a data type identifier, a data location identifier, a format descriptor, a schema representation, a sensitivity classification, and any applicable access constraints. Metadata store 130 defines the sole channel through which information about the contents of data environment 170 is made available to LLM 162 and AI agents 164 within LLM and AI agent layer 160. No component within LLM and AI agent layer 160 has access to metadata store 130 except through the read interface managed by the platform; no component within that layer has any access pathway, direct or indirect, to sensitive data repository 172.

Governing all data retrieval from data environment 170 is security policy engine 140, which manages and enforces the access control policies that determine which components may retrieve which data and under what conditions. Security policy engine 140 maintains a policy store comprising role-based access control definitions, data classification based access rules, temporal constraints, purpose-of-use limitations, and elevated access conditions. Security policy engine 140 implements a zero trust authorization model that evaluates every data retrieval request as untrusted regardless of origin, authentication state, or network location, and authorizes or denies each request based solely on the applicable policy rules. Security policy engine 140 integrates with the broader security infrastructure of the enterprise, including authentication, logging, and incident management systems, and supports policy definition through both direct administrator configuration and the LLM assisted methodology described in Section 4 herein.

Controlled data interface 150 serves as the exclusive pathway through which data from data environment 170 can be retrieved by system components other than sensitive data analyzer 110 and data monitoring application 120. Before any data access is attempted, controlled data interface 150 submits each retrieval request to security policy engine 140 for evaluation; requests that do not satisfy applicable policy requirements are denied without data exposure. Controlled data interface 150 generates an immutable audit trail entry for every access event, comprising the identity of the requesting entity, the identifier of the data reference invoked, a timestamp, the disposition of the access request, and, for authorized requests, a record of the data retrieved. The audit trail is stored in a tamper-evident log repository suitable for integration with enterprise security information and event management platforms.

LLM and AI agent layer 160 contains LLM 162 and one or more AI agents 164 and is architecturally separated from data environment 170. Neither LLM 162 nor any AI agent 164 possesses a data path to sensitive data repository 172 other than through sequential traversal of metadata store 130, security policy engine 140, and controlled data interface 150, in that order. LLM 162 does not receive raw sensitive data at any point in any workflow supported by system 100 and operates exclusively on metadata, data references, or processed output from processing tool 180.

Processing tool 180 sits outside the execution context of LLM 162 and receives data retrieved through controlled data interface 150. Because the LLM never participates in raw data processing, processing tool 180 performs the specified analytical operations without LLM involvement. Processed output from processing tool 180 is provided to user interface 190 for presentation, with LLM 162 optionally employed to format or summarize the processed results for natural language presentation to users. Data environment 170 contains sensitive data repository 172, which stores the enterprise data protected by the architecture of system 100. In operation, LLM 162 is excluded from any executable data retrieval path and instead operates on metadata and processed outputs at all times.

### 2. Reference Based Data Access Methodology Within Artificial Intelligence Agent Workflows

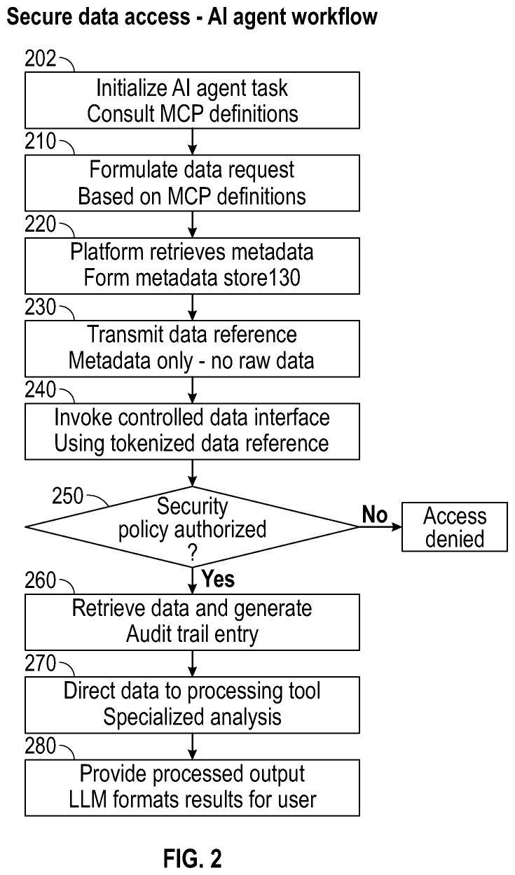

Referring now to FIG. 2, a method for secure data access within an AI agent workflow is illustrated. The technical advancement of this methodology over prior LLM integrated data access approaches lies in the substitution of tokenized data references for actual data in the AI agent execution path, the enforcement of security policies at the sole authorized data retrieval interface, and the structural prohibition of any data path between LLM 162 and sensitive data repository 172. Because the architectural isolation is enforced at the system level rather than the behavioral level, it is not susceptible to adversarial circumvention through prompting strategies that have been demonstrated to defeat behavioral guardrails.

At step 202, an AI agent task is initialized. Upon receiving an assigned task, AI agent 164 consults metadata context protocol definitions that have been generated by the platform from the metadata held in metadata store 130. The metadata context protocol definitions describe available data resources—their types, locations, format characteristics, and sensitivity levels—using the metadata vocabulary of the platform without exposing any content from sensitive data repository 172. The metadata context protocol definitions are generated by LLM 162 operating on metadata retrieved from metadata store 130 and serve as a structured knowledge base enabling AI agent 164 to reason about available data assets and to formulate accurate data requests without possessing or requiring direct access to sensitive data.

At step 210, AI agent 164 formulates a data request based on the metadata context protocol definitions. The request specifies the category, type, or identifier of the data required for the assigned task using the metadata schema of the platform. At step 220, the platform receives the data request, retrieves the applicable metadata entries from metadata store 130, and constructs a tokenized data reference object comprising at minimum the data type identifier, the data location identifier, the sensitivity classification, and the applicable access constraints associated with the requested data. The data reference is a structured, tokenized object; it identifies and describes the data through encoded metadata without encapsulating or transmitting any content of sensitive data repository 172.

At step 230, the tokenized data reference is transmitted to AI agent 164 in response to the data request. Only encoded metadata is communicated; no sensitive data content is conveyed at this step. In an exemplary embodiment, a virtual schema may be associated with the data reference to enable AI agent 164 to reason about the structural properties and field semantics of the data without accessing its content. At step 240, AI agent 164 invokes controlled data interface 150 using the tokenized data reference to initiate an authorized data retrieval operation. The invocation constitutes a formal, policy governed access request.

At step 250, security policy engine 140 evaluates the access request against the applicable policies governing the requesting entity, the requested data classification, and the declared purpose of the request, applying the zero trust authorization model. If the request is denied, access is refused and the denial is logged in the audit trail without any data exposure. If the request is authorized, controlled data interface 150 retrieves the data at step 260 and generates an audit trail entry recording the details of the access event. Processing tool 180 then receives the retrieved data at step 270 and executes the analytical operations required by AI agent 164. At step 280, AI agent 164 receives the processed output for use in completing the assigned task. LLM 162 may optionally format that output for presentation to a user through user interface 190. Because LLM 162 receives only processed output from processing tool 180, its structural exposure to sensitive information is limited to whatever information survives the processing step, and raw sensitive data content is never present in the LLM execution context.

### 3. Application Programming Interface Generation with Architecturally Enforced Data Security

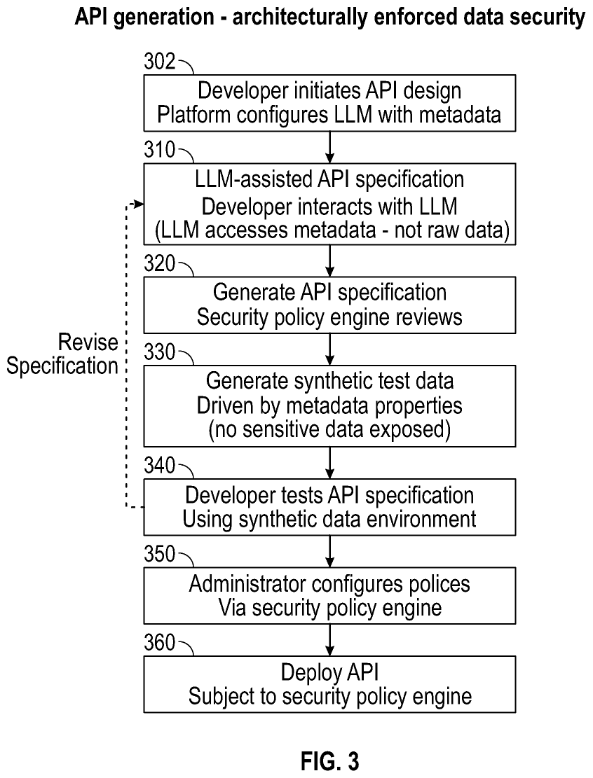

Referring now to FIG. 3, a method for API generation with architecturally enforced data security is illustrated. This methodology enables application developers to produce accurate, production ready API specifications with the assistance of LLM 162 and to test those specifications against realistic synthetic data, without requiring or receiving access to sensitive data in production data environments at any stage of the development lifecycle. The technical improvement over conventional API development practice consists in the resolution of the tension between development velocity and data security through architectural means, specifically the provisioning of a metadata informed LLM assistant and a dynamically generated synthetic data environment in lieu of production data access.

At step 302, a developer initiates an API design session. The platform configures LLM 162 with a knowledge context derived from metadata store 130, providing LLM 162 with a current, detailed representation of the structure, format, sensitivity characteristics, and relational properties of available data resources in data environment 170. LLM 162 does not receive any content from sensitive data repository 172 during or subsequent to this configuration step.

At step 310, the developer interacts with LLM 162 to specify the functional requirements of the API, including the data operations to be supported, expected input parameters, response schemas, and any applicable data transformation requirements. LLM 162, operating on the metadata context established at step 302, assists the developer in generating API specifications that accurately reflect the structure, types, and constraints of the underlying data assets without requiring the developer or LLM 162 to access production data.

At step 320, the platform generates an API specification incorporating the developer inputs and the metadata knowledge of LLM 162. Security policy engine 140 performs a policy review of the specification to identify any defined endpoints or data operations that would circumvent applicable access control policies upon deployment, and the specification is revised to eliminate identified policy violations before proceeding.

At step 330, the platform dynamically generates synthetic test data on demand. Synthetic data generation is driven by the structural and statistical properties of the real data as encoded in metadata store 130, including field types, format patterns, value distributions, interfield dependencies, cardinality constraints, and edge case characteristics. The generated synthetic data is of sufficient structural and distributional fidelity to support realistic development and integration testing without including any actual records from sensitive data repository 172. In an exemplary embodiment, a third-party synthetic data generation service may cooperate with the platform's metadata knowledge to produce the synthetic data.

At steps 340 and 350, the developer tests the API specification using the synthetic data environment, and a system administrator configures deployment policies through security policy engine 140, specifying authorized consumers, permissible operations, rate limits, and audit requirements. At step 360, the API is deployed subject to enforcement of all applicable policies by controlled data interface 150.

### 4. Large Language Model Assisted Security Policy Formulation Using Transformed Metadata

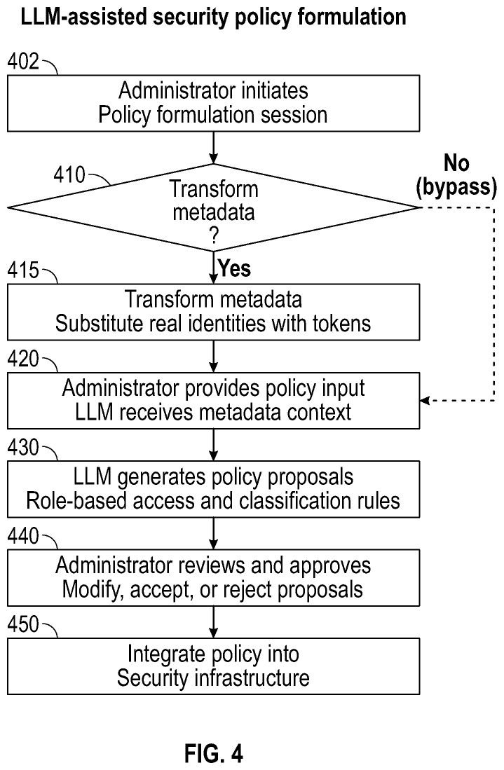

Referring now to FIG. 4, a method for LLM assisted security policy formulation is illustrated. This methodology addresses a technical problem in enterprise security management: the formulation of granular, contextually accurate access control policies is cognitively demanding and error prone when performed manually, but delegating policy formulation to an LLM that has access to business data introduces unacceptable data exposure risk. The methodology resolves this problem by providing an LLM assisted policy formulation workflow in which the LLM operates exclusively on metadata—and optionally on transformed metadata from which actual resource identifiers have been replaced with generic tokens—while the security relevance and accuracy of the generated policies are preserved by the completeness of the structural and relational information encoded in the metadata.

At step 402, a system administrator initiates a policy formulation session. At step 410, the platform evaluates whether metadata transformation is appropriate for the session. If selected, at step 415 the platform applies a transformation that substitutes actual names of data resources, organizational units, database tables, column identifiers, and individual identifiers with generic, nonidentifying placeholders using a tokenization scheme that preserves structural relationships and relational semantics while obscuring the identity of specific enterprise data assets. This transformation prevents LLM 162 from developing or retaining knowledge of the enterprise's specific data architecture, organizational structure, or data asset nomenclature, while preserving the information necessary for generating accurate and contextually appropriate policy suggestions.

At steps 420 and 430, the administrator provides policy requirements to LLM 162, and LLM 162 generates proposed access control policies based on the administrator input and the available metadata context. Proposed policies may include role-based access definitions, classification based access rules, temporal restrictions, purpose-of-use limitations, elevated access conditions, and cross role conflict analyses. LLM 162 may identify potential coverage gaps or inconsistencies in existing policies based on the metadata and suggest remedial policy modifications.

At steps 440 and 450, the administrator reviews, modifies, approves, or rejects proposed policy elements, and approved policies are integrated directly into security policy engine 140 without requiring manual schema translation or format conversion. Deployed policies govern all subsequent data access operations through controlled data interface 150.

### 5. Enforced Layered Security Architecture

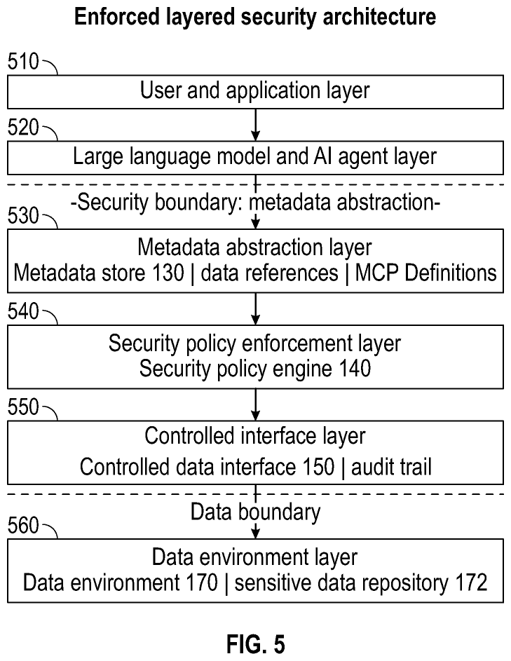

Referring now to FIG. 5, the enforced layered security architecture of system 100 is illustrated. The layered architecture depicted in FIG. 5 is not merely an organizational description of system components; it represents a technical architecture in which each layer defines the boundary of permissible operations for the components within it, and in which the architectural boundaries between layers are enforced by the platform at runtime in a manner that cannot be bypassed through LLM configuration, prompt manipulation, or credential exploitation alone. This enforced, multilayer boundary structure constitutes a technical improvement over prior LLM deployment architectures that rely on behavioral constraints for data confidentiality.

User and application layer 510 is the topmost layer and represents the interface through which human users and external applications interact with system 100. LLM and AI agent layer 520 resides directly below and contains LLM 162 and AI agents 164. The dashed security boundary indicated in FIG. 5 between LLM and AI agent layer 520 and metadata abstraction layer 530 represents the primary enforced architectural boundary of system 100. This boundary is structurally implemented: no component within LLM and AI agent layer 520 possesses any data path to data environment layer 560 other than through the sequential traversal of metadata abstraction layer 530, security policy enforcement layer 540, and controlled interface layer 550 in that order. The inability of components within LLM and AI agent layer 520 to directly access data environment layer 560 is a structural property of the architecture, not a behavioral property of the LLM.

Metadata abstraction layer 530 maintains metadata store 130 and manages the issuance and resolution of tokenized data references. All information about the data landscape of data environment 170 that is accessible to components within LLM and AI agent layer 520 is mediated through metadata abstraction layer 530 and is limited to metadata level information. Security policy enforcement layer 540 contains security policy engine 140 and evaluates all data retrieval requests submitted through controlled data interface 150 prior to any data access. Controlled interface layer 550 contains controlled data interface 150 and is the sole execution point at which data from data environment layer 560 can be retrieved by processing tool 180.

The dashed data boundary indicated in FIG. 5 between controlled interface layer 550 and data environment layer 560 represents the second enforced boundary of system 100, at which authorization from security policy enforcement layer 540 is a prerequisite for any data access. Data environment layer 560 contains data environment 170 and sensitive data repository 172. The two enforced boundaries of the architecture—the security boundary and the data boundary—together ensure that LLM 162 and AI agents 164 are structurally and irrevocably isolated from direct access to sensitive data repository 172, and that the only pathway to that data traverses both the metadata abstraction layer and the security policy enforcement layer.

### 6. Implementation

The systems, methods, and computer-readable media described herein may be implemented on one or more computing devices comprising at least one processor and at least one non-transitory computer-readable medium storing instructions executable by the processor. Platform components—sensitive data analyzer 110, data monitoring application 120, metadata store 130, security policy engine 140, and controlled data interface 150—may be implemented as discrete software modules, containerized microservices, or integrated components of a unified platform application. The exemplary embodiments are not limited to any particular implementation architecture, and components may be distributed across multiple physical or virtual nodes appropriate to the deployment environment.

In exemplary embodiments, sensitive data analyzer 110 employs a multistage classification pipeline comprising an initial tokenization and normalization stage, a feature extraction stage employing convolutional and recurrent neural network architectures for pattern recognition across heterogeneous data formats, a sequence labeling stage employing transformer based models fine tuned on enterprise specific training corpora, and a post classification heuristic review stage applying configurable rule sets for regulatory category assignment. The output of this pipeline for each classified element is a structured metadata record encoding the element's data type, sensitivity tier, location, schema fragment, and applicable regulatory categories, which is written to metadata store 130.

Tokenized data reference objects issued by the platform comprise, in exemplary embodiments, a reference identifier token generated using a cryptographically secure pseudorandom function, a metadata payload comprising the encoded metadata fields described above, an access constraint block specifying any applicable restrictions derived from security policy engine 140, an expiration timestamp, and a digital signature verifying the provenance and integrity of the reference object. Controlled data interface 150 validates the digital signature and expiration timestamp of a received data reference prior to submitting the associated retrieval request to security policy engine 140 for policy evaluation.

Security policy engine 140 implements a rule evaluation engine that processes policy rules expressed in a structured policy language and evaluates incoming retrieval requests against applicable rule sets. The rule evaluation engine applies rules in a defined priority order and supports policy constructs including attribute-based access control, context aware conditions, dynamic permission escalation for time-limited elevated access, and cross-reference rules that evaluate the relationship between the requesting entity's existing access history and the sensitivity classification of the requested data. The outcome of each policy evaluation is a binary authorization decision—grant or deny—together with a justification record that is appended to the audit trail.

The platform may be deployed within an enterprise cloud environment, an on-premises data center, or a hybrid environment. All intercomponent communications involving metadata, data references, or policy decisions are conducted over encrypted channels. The audit trail generated by controlled data interface 150 is stored in an immutable log repository with cryptographic integrity protection and may be integrated with existing security information and event management platforms. The synthetic data generation capability described herein employs, in exemplary embodiments, machine learning models trained on the statistical properties of real data as encoded in metadata to generate synthetic records of high structural fidelity without retaining sensitive content.

### 7. Exemplary Integrations With Related Disclosures

System 100 is built to operate in conjunction with, and materially enhance the security of, the data access and data management platforms disclosed in the related applications incorporated by reference herein. In each of the following examples, the reference based execution architecture functions as an LLM facing security layer that enforces metadata mediated execution atop an existing data access and proxy infrastructure. The combination in each case produces a technical result that neither platform achieves independently: specifically, the structural removal of LLM and AI agent components from the data retrieval path of an existing proxy or AI assisted data security system. Each example is nonlimiting. Persons of ordinary skill in the art will recognize that the specific configurations described may be varied in implementation detail without departing from the scope of the claims.

### Example 1—Integration with Systems and Methods for Managing Network Security (U.S. Provisional Patent Application Ser. No. 63/403,651)

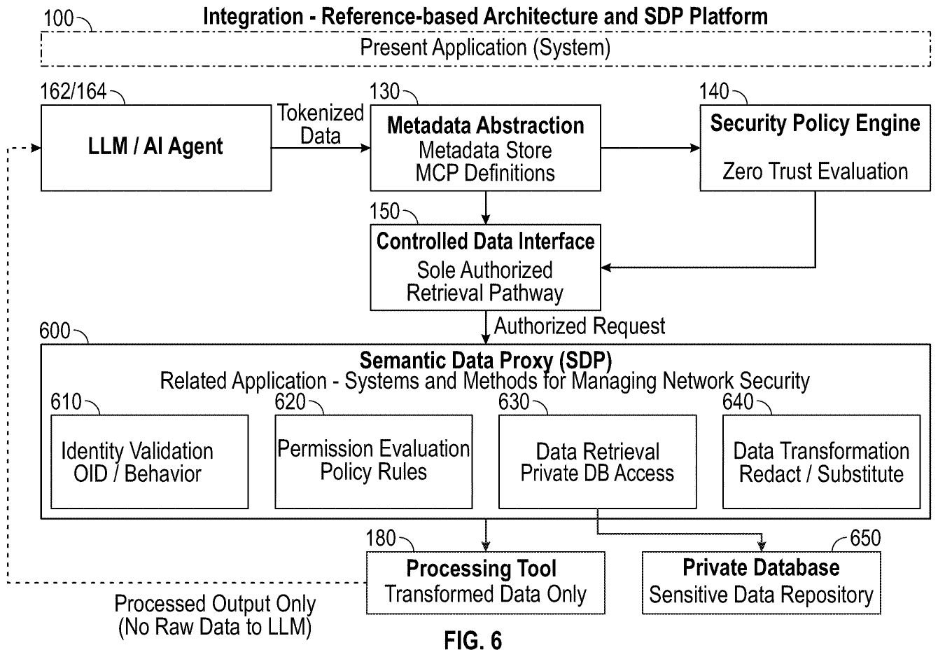

Referring now to FIG. 6, an exemplary integration of system 100 with the network security platform disclosed in the related application is illustrated. The related application discloses a Semantic Data Proxy (hereinafter “SDP”) positioned within the network flow between a private database and users or systems seeking access to data held therein. The SDP intercepts all inbound data access requests, validates the identity of the requesting entity through an Object Identifier system that examines user name, role, permission profile, request history, and behavioral patterns, inspects the nature of the requested data item including its confidentiality and sensitivity attributes, retrieves the requested data item from the private database upon verification, and transforms the data item in accordance with privacy rules before returning a response. Transformation operations available within the SDP include redaction, deletion, substitution, addition of synthetic information, and provision of proxy data in lieu of the actual data item. The SDP mimics the private database to the requesting entity, preventing that entity from directly accessing or being aware of the private database's actual structure.

In the integration depicted in FIG. 6, system 100 operates as an LLM facing overlay positioned above the SDP infrastructure of the related application. Working from the SDP's data asset inventory, sensitive data analyzer 110 classifies, indexes, and encodes each asset's type, location, schema, sensitivity tier, and applicable transformation rules into structured metadata records—without retrieving or exposing any underlying data content in the process. Those records are written to metadata store 130 and surfaced to LLM 162 and AI agents 164 exclusively through the metadata context protocol definitions described in Section 2. A data request from AI agent 164 is answered with a tokenized data reference object, not with a direct pass-through to the SDP.

Upon invocation of controlled data interface 150 with the tokenized data reference object, security policy engine 140 evaluates the retrieval request against applicable access control policies. Upon authorization, controlled data interface 150 submits the retrieval request to SDP 600, which applies its full pipeline through identity validation module 610, permission evaluation module 620, data retrieval module 630, and data transformation module 640 before returning the data item to the present platform. The data retrieval module 630 is communicatively connected to Private Database 650. The transformed data item is then directed to processing tool 180, which performs the analytical operations specified by AI agent 164. In this configuration, LLM 162 receives only the processed output of processing tool 180 and does not receive the data item as returned by SDP 600, whether in transformed or untransformed form. The reference based execution architecture thereby produces a two stage data governance arrangement in which SDP 600 governs data access and transformation at the database facing layer and system 100 governs what information reaches the LLM's execution context, with the result that neither the SDP's transformation artifacts nor the underlying data content is ever present in the LLM's input stream. SDP 600's existing privacy transformation operations continue to apply to all human-initiated access pathways, while system 100 exclusively governs AI agent and LLM mediated pathways, such that the two platforms operate on complementary and non-overlapping access populations without conflict.

### Example 2—Integration with Systems and Methods for Managing Data Security (U.S. Non-Provisional patent application Ser. No. 18/240,738).

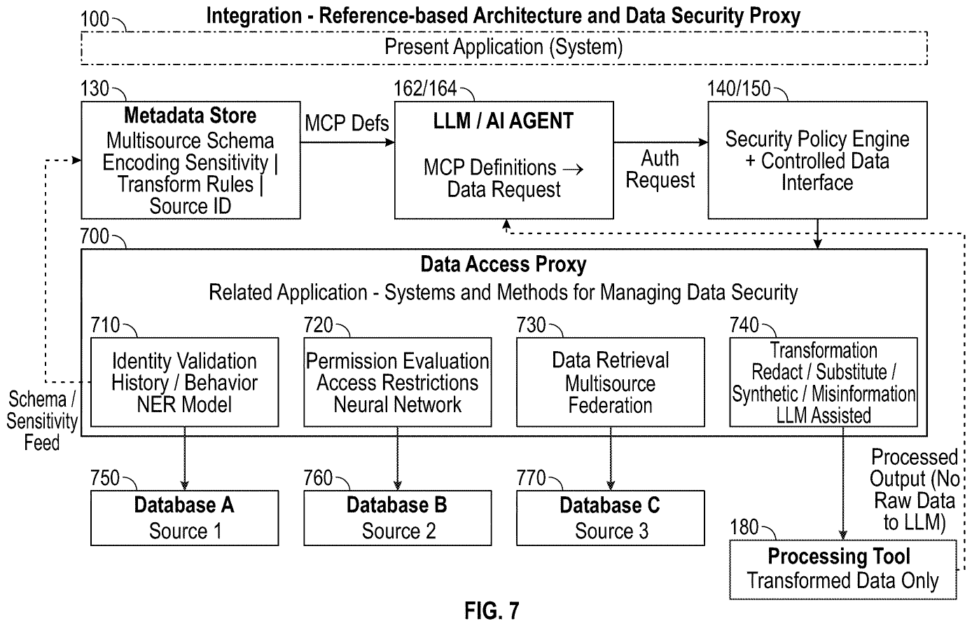

FIG. 7 depicts an integration of system 100 with the data security platform disclosed in the related application. The related application discloses a data access proxy 700 communicatively coupled with one or more private databases, the proxy operating to identify users and requests, validate permissions and identity at an identity validation module 710 through inspection of user activity history, behavioral patterns, and data specific access restrictions, retrieve requested data items at a data retrieval and federation module 730, inspect security attributes associated with those items, and transform the items according to applicable privacy rules at a data transformation module 740 before providing a response. The related application further discloses the use of artificial intelligence resources—specifically named-entity recognition models, large language models, and neural network supported applications—operating in conjunction with the data access proxy to enhance the accuracy of identity validation, sensitivity classification, and transformation decisions. The related application additionally addresses data migration and multisource data integration, enabling the data access proxy to federate access across heterogeneous data repositories behind a unified proxy interface.

System 100 takes direct advantage of the federation capability built into data access proxy 700 to extend the scope of metadata store 130. Because data access proxy 700 presents a unified interface across multiple disparate data sources, sensitive data analyzer 110 can classify, index, and encode metadata representations of data assets drawn from all federated sources—including database A 750, database B 760, and database C 770, representative of heterogeneous source types—through a single integration point, rather than requiring separate integrations with each underlying data repository. The resulting metadata store 130 reflects a comprehensive, multisource data landscape, with each metadata record encoding the source identifier, data type, schema fragment, sensitivity classification, and applicable transformation rules derived from the related application's privacy rule set for that asset.

When AI agent 164 requires data available through the federated proxy interface, the reference based execution architecture of system 100 issues a tokenized data reference object—constructed by reference generation module 160 and carrying in its metadata payload the source identifier and proxy routing information—necessary for controlled data interface 150 to direct the retrieval request to the correct underlying data source through the proxy. Security policy engine 140 evaluates the retrieval request, and upon authorization, controlled data interface 150 submits the request to data access proxy 700, specifying the target source. Data access proxy 700 applies its identity validation and permission evaluation pipeline through modules 710 and 730 —including the AI assisted named-entity recognition and behavioral analysis components of the related application—before retrieving and transforming the data item. The transformed item is returned to processing tool 180 of system 100, which performs the analytical operations required by the AI agent. As a result, LLM 162 is prevented from accessing the data retrieval path and operates exclusively on the processed output of processing tool 180; it receives no data from data access proxy 700, whether before or after transformation. The AI resources of the related application govern data retrieval and transformation within the proxy layer, while LLM 162 governs user facing response generation at the output layer, with the result that two distinct AI subsystems perform complementary and nonconflicting functions without either subsystem having visibility into the other's execution context or data inputs.

### Example 3—Integration with Fast Zero Trust Solution to Data Access and Data Integration (U.S. Provisional patent application Ser. No. 63/466,641).

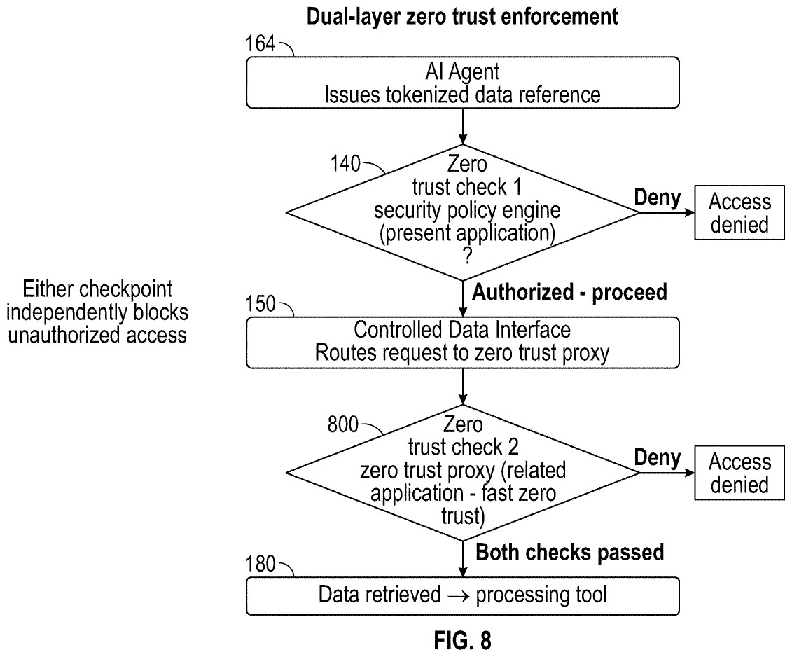

The integration shown in FIG. 8 combines system 100 with the zero trust data access and integration platform disclosed in the related application. The related application discloses a network security and data integration platform implementing a zero trust access model through a proxy database engine, wherein no user or system is presumed authorized to access private data without explicit, continuous per request verification regardless of network location, authentication state, or prior access history. The related application addresses both the data access security challenge—specifically the failure of perimeter based approaches to protect payload level data in encrypted transport environments—and the practical data integration challenge of providing unified, governed access to data distributed across disparate sources. The proxy of the related application (hereinafter zero trust proxy 800) functions as a Semantic Data Proxy, intercepting requests, validating identity, inspecting behavioral patterns, and applying data transformation before responding.

What makes this integration distinctive is the presence of two fully independent zero trust enforcement checkpoints, one from each platform, that every retrieval request from AI agent 164 must traverse in sequence. Security policy engine 140 is the first. Before any contact with the data layer is initiated, it evaluates the request against the policies maintained by system 100, treating the request as untrusted regardless of the requesting agent's operational context or prior authorization history. Only requests that clear this checkpoint are forwarded.

The second checkpoint is zero trust proxy 800 of the related application, which independently validates the identity and authorization of the retrieval request received from controlled data interface 150, applies its own per request behavioral evaluation, and retrieves and transforms the requested data only upon independent authorization. Because each checkpoint applies zero trust principles in full without reference to the outcome of the other checkpoint, neither checkpoint constitutes a single point of failure for the combined architecture. A failure of behavioral constraint, misconfiguration, or credential compromise at either layer alone is insufficient to expose sensitive data to AI agent 164 or LLM 162. The practical effect of this arrangement is that the reference based execution architecture structurally prevents LLM 162 from accessing the data retrieval path: LLM 162 receives no data from zero trust proxy 800 and operates exclusively on the processed output of processing tool 180, with its exposure to data content reduced to a structural minimum enforced at the architecture level. In addition, the data integration capability of the related application—its ability to present unified access to data distributed across multiple heterogeneous sources—extends the operational reach of system 100 without requiring modification to the metadata store 130 population process, as the proxy's unified interface provides a single integration target for sensitive data analyzer 110.

### Example 4—Integration with Systems and Methods for Ransomware Events, Provisional (U.S. Provisional patent application Ser. No. 63/567,385).

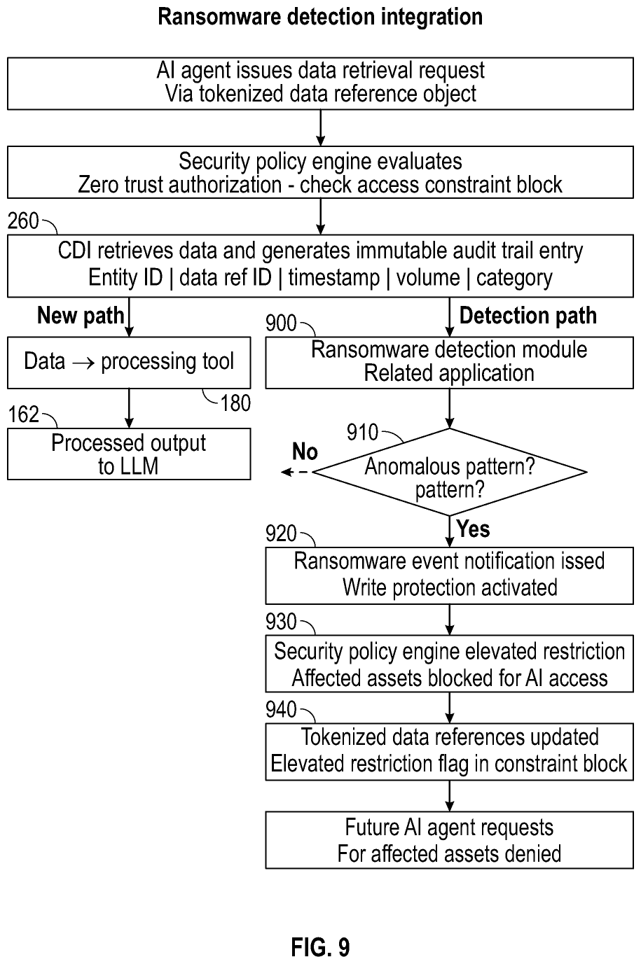

FIG. 9 illustrates how system 100 operates alongside the ransomware defense platform disclosed in the provisional application. The related application discloses a data security platform incorporating a data access proxy that, in addition to performing identity validation, permission evaluation, data retrieval, and transformation functions, detects and responds to ransomware events. Ransomware event detection in the related application is predicated on the identification of anomalous data access and modification patterns—specifically, the recognition of unauthorized format changes in data items such as mass encryption of database content by a ransomware process—and the application of write protection policies to prevent a ransomware process from propagating encrypted or corrupted data back to its source repository. The related application's proxy serves as a data level firewall capable of distinguishing legitimate data access patterns from the behavioral signatures of active ransomware processes.

The structural connection between the two platforms runs through the audit trail. The immutable audit trail generated by controlled data interface 150 for each AI agent initiated data retrieval event constitutes a structured, tamper-evident behavioral record that the ransomware detection layer of the related application can ingest and analyze for anomalous patterns. Each entry in that trail records the requesting entity identifier, the data reference identifier, a timestamp, the volume and category of data retrieved, and the disposition of the request. That level of semantic detail matters because AI agents can legitimately issue large numbers of automated retrieval requests in rapid succession—a pattern statistically similar at the network layer to ransomware reconnaissance or bulk exfiltration. Feeding the structured audit trail into the ransomware detection layer of the related application gives that layer a far richer behavioral signal than raw traffic analysis alone.

The feedback also runs in the other direction. When ransomware detection module 900 detects an active ransomware event and activates write protection or access suspension for an affected data asset, system 100 receives a ransomware event notification 920 and security policy engine 140 is configured to apply an elevated restriction policy 930 to that asset, as contemplated by the ransomware defense architecture. Under the elevated restriction policy, controlled data interface 150 declines to authorize AI agent retrieval requests for the affected data asset regardless of whether the requesting AI agent satisfies all other applicable access control criteria, and the tokenized data reference objects issued for that asset by system 100 are updated 940 to encode the elevated restriction status in their access constraint block. The reference based execution architecture thereby creates a closed feedback loop: the audit trail it generates improves the ransomware detection platform's discrimination accuracy, and the ransomware detection platform's event notifications dynamically tighten the access permissions enforced by system 100, with neither platform requiring architectural modification to the other.

### Example 5—Integration with Systems and Methods for Ransomware Events, Non-Provisional (U.S. Non-Provisional patent application Ser. No. 19/081,839)

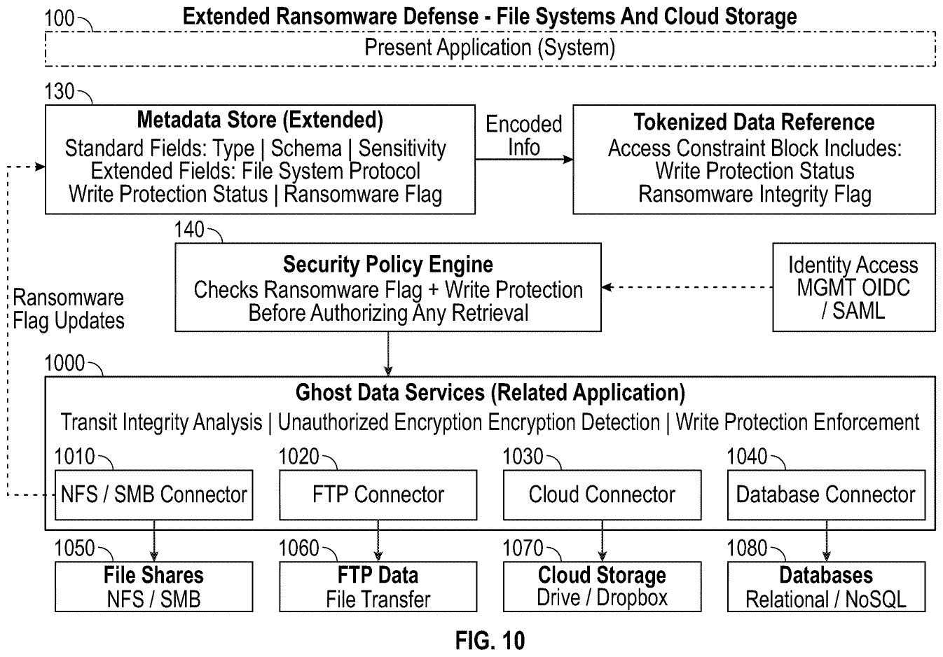

The integration depicted in FIG. 10 extends the ransomware scenario of Example 4 to the broader platform disclosed in the non-provisional application. The non-provisional application extends the ransomware defense architecture of the provisional application to encompass data sources beyond relational databases, including NFS and SMB file system shares, cloud hosted storage platforms such as Google Drive and Dropbox, and data exchanged through FTP and similar file transfer protocols. The extended platform, referred to in the related application as incorporating “Ghost Data Services” 1000, positions Dymium Connectors at the edge of the data environment as secure TLS connected gateways to these disparate file system and cloud storage sources, including an NFS and SMB connector 1010, an FTP connector 1020, a cloud storage connector 1030, and a database connector 1040, with identity and access management governed by an IAM module 1050. The Ghost Data Services layer analyzes data integrity during transit, identifies unauthorized encryption or format modification of data items in real time, and applies write protection to prevent the reintegration of compromised data to its origin repository. The platform further employs AI and machine learning behavioral algorithms within the proxy layer to refine its discrimination between legitimate access patterns and ransomware behavioral signatures over time.

To cover the file system and cloud storage sources managed by Ghost Data Services 1000, sensitive data analyzer 110 is extended to classify, index, and encode metadata representations of data assets stored in the file system and cloud storage sources covered by the related application's Ghost Data Services and Dymium Connector infrastructure, in addition to the relational database assets covered in prior exemplary embodiments. Metadata records generated for file system assets encode, in addition to the standard type, location, schema, and sensitivity fields, the file system protocol through which the asset is accessible (NFS, SMB, or cloud storage API), the applicable write protection status as maintained by the Ghost Data Services layer, and a ransomware integrity flag indicating whether the asset has been flagged as potentially compromised by the Ghost Data Services' transit integrity analysis. These additional metadata fields are encoded as attributes within the access constraint block of the tokenized data reference objects issued for file system and cloud storage assets.

When AI agent 164 requests access to a file system asset through system 100, the tokenized data reference object issued by the reference based execution architecture and returned to AI agent 164 includes the write protection status and ransomware integrity flag for that asset as metadata attributes, enabling AI agent 164 to reason through the metadata context protocol definitions about the current integrity and accessibility status of the requested asset without directly accessing Ghost Data Services 1000. Security policy engine 140, upon receiving the retrieval request at controlled data interface 150, evaluates the ransomware integrity flag and write protection status encoded in the access constraint block of the data reference as part of its policy evaluation before authorizing retrieval. Assets carrying an active ransomware flag or a write protection status are subject to an elevated restriction policy that prevents retrieval through controlled data interface 150 until Ghost Data Services 1000 has cleared the integrity flag, irrespective of whether all other access control criteria are satisfied. Across file system and cloud storage assets, LLM 162 is prevented from accessing the data retrieval path in the same manner as for relational database assets: it receives only the processed output of processing tool 180 and has no data path to the underlying stores or repositories managed by connectors 1010 through 1040. The behavioral intelligence accumulated by the Ghost Data Services AI and machine learning subsystems—regarding asset integrity and safety—is propagated into the AI agent execution path of system 100 through the structured metadata and access constraint encoding of the tokenized data reference, without requiring direct communication between AI agent 164 and Ghost Data Services 1000.

### Example 6—Integration with Artificially Intelligent Systems and Methods for Managing Data Security (U.S. Non-Provisional patent application Ser. No. 18/893,774)

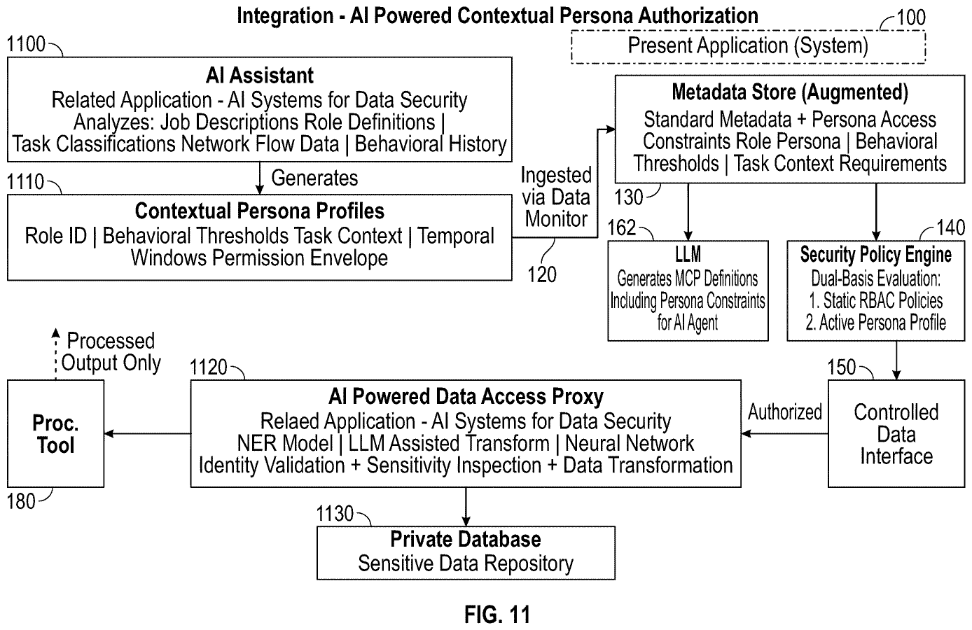

FIG. 11 shows the integration of system 100 with the AI powered data security platform disclosed in the related application. That platform incorporates an AI powered assistant 1100 operating within the data access proxy layer. AI assistant 1100 automatically analyzes available organizational data—job descriptions, role definitions, task classifications, and network access flow data—to generate contextual frameworks and persona profiles for users and system entities. Each contextual persona profile 1110 is a structured record capturing the expected data access behavior, permission envelope, and task context appropriate to a given organizational role, derived by AI assistant 1100 from its analysis of role definitions and behavioral history. The AI assistant draws on these profiles to interpret data access requests, personalize responses, and guide users through access processes in a way that reflects the organizational context of the requesting entity. The related application further discloses an AI powered data access proxy 1120 employing named-entity recognition models, large language models, and neural network supported AI applications to validate user identity, evaluate request legitimacy, inspect data item sensitivity, and transform data items before release.

The central mechanism of this integration is the ingestion of contextual persona profiles 1110, generated by AI assistant 1100 of the related application, into metadata store 130 of system 100 as access constraint attributes associated with the data assets and user roles to which each persona applies. The ingestion process is performed by data monitoring application 120, which maintains a continuous subscription to persona profile updates published by the AI assistant of the related application and propagates those updates to the relevant metadata records in metadata store 130. Each metadata record for a data asset subject to persona based access governance is augmented with an access constraint attribute block encoding the role identifiers, behavioral thresholds, task context requirements, and temporal validity windows of the applicable contextual persona profiles 1110. When LLM 162 generates metadata context protocol definitions from the metadata store for consumption by AI agent 164, those definitions include the persona derived access constraint attributes from profiles 1110 in their characterization of available data assets, enabling AI agent 164 to formulate data requests that accurately reflect the persona based constraints applicable to the requesting context.

When controlled data interface 150 receives a retrieval request, security policy engine 140 evaluates it against both the static role-based access control policies maintained by system 100 and the dynamic persona based access constraint attributes ingested from AI assistant 1100. That two-track evaluation means access control decisions reflect not merely the requesting entity's formal role permissions but also whether the access request is behaviorally consistent with what that entity's active persona profile would predict. A request that satisfies the static role-based policies but falls outside the behavioral envelope defined by the active contextual persona is subject to additional scrutiny or denial by security policy engine 140, depending on the applicable policy configuration. Upon authorization, controlled data interface 150 routes the retrieval request to AI powered data access proxy 1120 of the related application, which applies its own AI assisted identity validation, sensitivity inspection, and data transformation pipeline before returning the data item to processing tool 180. LLM 162 receives only the processed output of processing tool 180. The AI assistant of the related application and LLM 162 of system 100 therefore operate at structurally distinct layers of the combined architecture—the AI assistant governs data access and transformation with contextual organizational intelligence at the proxy layer, while LLM 162 governs user facing response generation at the output layer—with neither AI subsystem having visibility into the execution context or raw data inputs of the other. That structural separation ensures the combined architecture does not open a channel through which adversarial manipulation of LLM 162 could compromise the contextual access governance performed by the AI assistant, or vice versa.

The examples set out above are illustrative of certain nonlimiting configurations in which the reference based execution architecture of the present application operates in conjunction with the related disclosures. The component interactions, data flows, and policy evaluation sequences described in each example represent one skilled implementation; many other configurations are achievable through combination of system 100 with the related platforms. Other configurations, combinations, and operational sequences will be apparent to those skilled in the art and are within the scope of the claims appended hereto. Across all six of these integrations, the reference based execution architecture operates as a universal overlay enforcing a structural separation between artificial intelligence components and the data retrieval layer, independent of whatever data access platform sits beneath it. That consistency is a direct consequence of how the boundary is implemented: the sequential traversal requirement through metadata abstraction layer 530, security policy enforcement layer 540, and controlled interface layer 550 applies whether the underlying infrastructure is a semantic proxy, a zero trust platform, a ransomware defense system, or an AI powered data security platform—and in none of those configurations does system 100 require modification.

While specific exemplary embodiments have been described above, various modifications are possible within the scope of the claims. Processes may be performed in a different order, steps may be deleted, added, combined, or subdivided, and elements may be combined or substituted without departing from the scope of the claims. What matters for purposes of scope is the claims, not any particular embodiment described in this specification.

What is claimed is:

1. A computer-implemented method for implementing a reference based execution architecture that structurally separates a large language model from a data environment containing sensitive data, the method comprising:
classifying, indexing, and encoding, by a sensitive data analyzer executing on at least one processor, sensitive data elements within the data environment, producing for each classified element a structured metadata record comprising at least a data type identifier, a data location identifier, a sensitivity classification, and a schema representation;
storing the structured metadata records in a metadata store that serves as the exclusive channel through which information about the contents of the data environment is made available to the large language model and to one or more artificial intelligence agents;
receiving a data request from an artificial intelligence agent, the data request being formulated based on metadata context information derived from the metadata store without exposing any sensitive data to the artificial intelligence agent;
constructing and transmitting, in response to the data request, a tokenized data reference object to the artificial intelligence agent, the tokenized data reference object comprising encoded metadata associated with the requested data and being transmitted in lieu of the sensitive data;
receiving, at a controlled data interface that defines a sole authorized data retrieval pathway from the data environment, an access request invoking the tokenized data reference object;
evaluating, prior to any data retrieval, the access request against one or more security policies maintained by a security policy engine, the evaluation applying a zero trust authorization model that treats the access request as untrusted regardless of the identity or authentication state of the requesting entity;
upon authorization, retrieving data from the data environment through the controlled data interface and generating an immutable audit trail entry recording the access event;
directing the retrieved data to a specialized processing tool operating outside the execution context of the large language model; and
providing processed output from the specialized processing tool for use by the artificial intelligence agent and for presentation to a user, the large language model operating only on the processed output and not on raw sensitive data.

2. The method of claim 1, further comprising generating metadata context protocol definitions from the structured metadata records, the metadata context protocol definitions describing available data resources in terms of their type, location, format, and sensitivity classification for use by the artificial intelligence agent in formulating data requests, the generation of the metadata context protocol definitions being performed without transmitting any content of the data environment to the large language model.

3. The method of claim 1, further comprising continuously monitoring the data environment to detect changes in data structure or the introduction of new data assets, and updating the structured metadata records in the metadata store in response to detected changes so as to maintain a current metadata representation of the data landscape within the data environment.

4. The method of claim 1, further comprising associating a virtual schema with the tokenized data reference object, the virtual schema enabling the artificial intelligence agent to reason about the structural properties and field semantics of the requested data without accessing the content of the sensitive data elements.

5. The method of claim 1, the sensitive data elements comprising at least one of personally identifiable information, confidential business records, financial data, health-related information, and legally protected information, the sensitivity classification encoding a regulatory category applicable to the classified element.

6. The method of claim 1, the tokenized data reference object further comprising a cryptographically secure reference identifier token, an access constraint block derived from the security policies applicable to the classified sensitivity of the associated data, an expiration timestamp, and a digital signature verifying the provenance and integrity of the tokenized data reference object, the controlled data interface validating the digital signature and expiration timestamp prior to submitting the access request to the security policy engine.

7. The method of claim 1, the method further comprising:
configuring the large language model with a knowledge context derived from the structured metadata records;
receiving developer input specifying requirements for an application programming interface through interaction with the large language model, the large language model operating on the metadata knowledge context without accessing sensitive data from the data environment;
generating an application programming interface specification based on the developer input and the metadata knowledge context;
performing a policy review of the application programming interface specification by the security policy engine to identify any defined operations that would circumvent applicable access control policies; and
deploying the application programming interface specification subject to enforcement of access control policies maintained by the security policy engine.

8. The method of claim 7, further comprising generating synthetic test data dynamically and on demand based on structural and statistical properties encoded in the structured metadata records, the synthetic test data reflecting field types, format patterns, value distributions, interfield dependencies, and cardinality constraints of the sensitive data elements without including any actual records from the data environment, the synthetic test data being generated for developer testing of the application programming interface specification.

9. The method of claim 1, the method further comprising:
applying a metadata transformation to the structured metadata records to substitute actual data resource identifiers, organizational unit identifiers, and individual identifiers with generic placeholder tokens using a tokenization scheme that preserves structural relationships and relational semantics among the substituted elements while obscuring the identity of specific enterprise data assets;
generating, by the large language model operating on the transformed metadata, proposed data access security policies comprising at least role-based access definitions, classification based access rules, and temporal access constraints;
presenting the proposed data access security policies to a system administrator for review, modification, and approval; and
integrating approved data access security policies into a security infrastructure associated with the data environment without requiring manual schema translation, the integrated policies governing subsequent data retrieval operations through the controlled data interface.

10. The method of claim 9, the large language model further identifying potential coverage gaps or inconsistencies in existing access control policies based on the transformed metadata and generating proposed remedial policy modifications addressing identified gaps, the proposed remedial modifications being presented to the system administrator for review alongside the proposed data access security policies.

11. A system implementing a reference based execution architecture for structurally separating a large language model from a data environment, the system comprising:
at least one processor; and
at least one non-transitory computer-readable medium storing instructions that, when executed by the at least one processor, cause the system to implement:
a sensitive data analyzer configured to classify, index, and encode sensitive data elements within the data environment, producing for each classified element a structured metadata record comprising at least a data type identifier, a data location identifier, a sensitivity classification, and a schema representation;
a metadata store that stores the structured metadata records and defines a sole channel through which information about the data environment is accessible to the large language model and one or more artificial intelligence agents;
a security policy engine configured to maintain access control policies and to evaluate data retrieval requests against the access control policies prior to any data retrieval, the security policy engine applying a zero trust authorization model;
a controlled data interface that defines a sole authorized retrieval pathway from the data environment, the controlled data interface enforcing access control policies maintained by the security policy engine prior to executing any retrieval operation and generating an immutable audit trail entry for each access event;
a reference generation module configured to construct and issue tokenized data reference objects in response to data requests from artificial intelligence agents, each tokenized data reference object comprising encoded metadata associated with the requested data and being issued in lieu of the sensitive data; and
a processing tool operating outside the execution context of the large language model, the processing tool configured to receive data retrieved through the controlled data interface and to provide processed output to the large language model for use in presenting results to a user, the large language model operating only on the processed output and never on raw sensitive data from the data environment.

12. The system of claim 11, the sensitive data analyzer further configured to employ a multistage classification pipeline comprising a feature extraction stage applying neural network models to identify sensitive data element candidates, a sequence labeling stage applying transformer based models fine tuned on enterprise specific training data, and a heuristic review stage applying configurable rule sets for regulatory category assignment.

13. The system of claim 11, the tokenized data reference object further comprising a cryptographically secure reference identifier token, an access constraint block, an expiration timestamp, and a digital signature, the controlled data interface validating the digital signature and expiration timestamp prior to submitting a retrieval request to the security policy engine.

14. The system of claim 11, further implementing a data monitoring application configured to continuously monitor the data environment for structural changes and to update the structured metadata records in the metadata store in response to detected changes, maintaining a current metadata representation of the data landscape.

15. The system of claim 11, implementing a layered security architecture comprising a large language model and artificial intelligence agent layer, a metadata abstraction layer containing the metadata store, a security policy enforcement layer containing the security policy engine, a controlled interface layer containing the controlled data interface, and a data environment layer containing the data environment, the architecture enforcing a first structural boundary between the large language model and artificial intelligence agent layer and the metadata abstraction layer and a second structural boundary between the controlled interface layer and the data environment layer, each boundary being enforced at runtime by the system such that no component within the large language model and artificial intelligence agent layer possesses a direct data path to the data environment layer.

16. The system of claim 11, further configured to generate metadata context protocol definitions from the structured metadata records for use by the artificial intelligence agents in formulating data requests, the metadata context protocol definitions describing available data resources in terms of type, location, format, and sensitivity classification without exposing any sensitive data to the large language model or artificial intelligence agents.

17. A non-transitory computer-readable medium storing instructions that, when executed by at least one processor, cause a computing system to implement a reference based execution architecture providing a structural separation between a large language model and a data environment, by performing operations comprising:
classifying, indexing, and encoding sensitive data elements within the data environment using a sensitive data analyzer, producing structured metadata records comprising at least a data type identifier, a data location identifier, a sensitivity classification, and a schema representation for each classified element;
maintaining a metadata store that holds the structured metadata records and defines a sole channel through which information about the data environment is accessible to the large language model and one or more artificial intelligence agents, with no direct data path existing between the large language model and the data environment;
constructing and transmitting a tokenized data reference object to an artificial intelligence agent in response to a data request, the tokenized data reference object comprising encoded metadata associated with the requested data and being transmitted in lieu of sensitive data from the data environment;
receiving an access request invoking the tokenized data reference object at a controlled data interface that defines a sole authorized data retrieval pathway from the data environment;
evaluating, prior to any data retrieval, the access request against access control policies maintained by a security policy engine, applying a zero trust authorization model;
upon authorization, retrieving data from the data environment through the controlled data interface and generating an immutable audit trail entry recording the access event;
directing the retrieved data to a specialized processing tool operating outside the execution context of the large language model; and
providing processed output from the specialized processing tool to the large language model, the large language model operating only on the processed output and not on raw sensitive data.

18. The non-transitory computer-readable medium of claim 17, the operations further comprising generating synthetic test data dynamically and on demand based on structural and statistical properties encoded in the structured metadata records, the synthetic test data reflecting field types, format patterns, value distributions, and interfield dependencies of the sensitive data elements without including any actual records from the data environment, the synthetic test data being generated for use in application programming interface development and testing.

19. The non-transitory computer-readable medium of claim 17, the operations further comprising applying a metadata transformation to the structured metadata records to substitute actual data resource identifiers with generic placeholder tokens prior to providing metadata to the large language model for security policy formulation assistance, the transformation preserving structural relationships and relational semantics among the substituted elements while obscuring the identity of specific enterprise data assets.

20. The non-transitory computer-readable medium of claim 17, the operations further comprising eliminating, as a structural property of the reference based execution architecture, any execution path through which the large language model can access raw sensitive data, the elimination being implemented by interposing the metadata abstraction layer, the security policy enforcement layer, and the controlled interface layer between the large language model and the data environment such that no data retrieval operation is executable by the large language model directly against the data environment.
